(19) United States
(12) Patent Application Publication
(10) Pub. No.: US 2014/0132848 A1
(43) Pub. Date: May 15, 2014

(54) ILLUMINATING DEVICE, DISPLAY DEVICE, AND TELEVISION RECEIVER

(71) Applicant: Hirokazu Mouri, Osaka (JP)

(72) Inventor: Hirokazu Mouri, Osaka (JP)

(73) Assignee: SHARP KABUSHIKI KAISHA, Osaka (JP)

(21) Appl. No.: 14/233,612

(22) PCT Filed: Jul. 13, 2012
(86) PCT No.: PCT/JP2012/067921

§ 371 Date: Jan. 17, 2014

(30) Foreign Application Priority Data
Jul. 21, 2011 (JP) 2011-159768

(51) Int. Cl. F21V 8/00

(52) U.S. Cl. CPC G02B 6/009
USPC 348/801; 362/613; 362/612; 349/65

(57) ABSTRACT

A backlight device 24 of the present invention includes: a chassis 22 that has a bottom plate 22a, and a side wall 22b that rises on the front side of the bottom plate 22a from an edge of the bottom plate 22a; a light guide plate 20 that has a light-receiving face 20a, a light-exiting surface 20b, and an opposite surface 20c, and that is arranged such that the opposite surface 20c faces the surface of the bottom plate 22a; an LED substrate 30 that is arranged on the surface the bottom plate 22a and that abuts the side wall 22b; an LED light source 28 arranged on a front face of the LED substrate 30; a frame 14 arranged above the light-exiting surface 20b of the light guide plate 20; a first inclined portion 31 that is provided on the frame 14 and that inclines from the light guide plate 20 side towards the side wall 22b and from the bottom plate 22a side towards the light-exiting surface 20b; and a first abutting portion 41 that is arranged on the LED substrate 30 and that has a least a portion thereof abutting an inclined face of the first inclined portion 31.

### TECHNICAL FIELD

The present invention relates to an illumination device, a display device, and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. Liquid crystal panels used in liquid crystal display devices do not emit light on their own, and therefore, it is necessary to provide a separate backlight device as an illumination device. A known example of such a backlight device is an edge-lit backlight device in which a light-receiving face is provided on a side face of a light guide plate, and a light source such as an LED is provided facing the side face of the light guide plate. In edge-lit backlight devices that use LEDs as a light source, the light guide plate is housed inside a casing, and a substrate on which the LEDs are mounted is fixed to a side wall of the casing, for example.

Edge-lit backlight devices that use LEDs as a light source are disclosed in Patent Document 1 and Patent Document 2. In the backlight device in Patent Document 1, the light guide plate is housed in a metal frame, which is the casing, and the substrate on which the LEDs are mounted is adhered and fixed to a side plate of the metal frame by an adhesive sheet. In the backlight device in Patent Document 2, the light guide plate is housed in a chassis, which is the casing, and the substrate on which the LEDs are mounted is attached and fixed to a side plate of the chassis by screw fastening or the like.

### RELATED ART DOCUMENTS

### Patent Documents

Patent Document 1: Japanese Patent Application Laid-Open Publication No. 2007-42338
Patent Document 2: Japanese Patent Application Laid-Open Publication No. 2011-103236

### Problems to be Solved by the Invention

However, in edge-lit backlight devices that use LEDs, in order to dissipate heat generated in the vicinity of the LEDs from the casing towards the side wall of the casing, it is necessary to closely fix the substrate on which the LEDs are mounted to the side wall of the casing. In the backlight device in Patent Document 1, however, whereas the substrate is adhered to the side wall side of the metal frame through the adhesive sheet, the heat resistance of the adhesive sheet is high; therefore, it is more difficult for heat to be transferred towards the side plate from the substrate than if the substrate were in direct contact with the side plate of the metal frame. In the backlight device in Patent Document 2, a large number of screws are necessary to adhere the substrate to the side wall of the chassis, resulting in an increase in labor time.

Furthermore, when arranging the LEDs on the substrate that the LEDs are mounted on, it is necessary to have holes in the substrate for fixing by the screws, and thus, it is necessary to avoid these holes when arranging the LEDs. This widens the gap between LEDs in the vicinity of the holes, and imposes restraints on placement of the LEDs, causing dark spots on the screen and the like.

### SUMMARY OF THE INVENTION

The invention disclosed in the present specification was made in view of the above-mentioned problems. The present invention provides an illumination device in which a light source substrate can be positioned and fixed to a chassis without using members such as screws.

### Means for Solving the Problems

The technology disclosed in the present specification relates to an illumination device including a chassis that has a bottom plate, and a side wall that rises on a surface side of the bottom plate from an edge of the bottom plate; a light guide plate that has a light-receiving face as a side face thereof, a light-exiting surface disposed on one plate surface of the light guide plate, and an opposite surface disposed on another plate surface that is opposite to the light-exiting surface, the light guide plate being arranged such that the opposite surface faces the above-mentioned surface side of the bottom plate; a light source substrate that is arranged on the surface side of the bottom plate and that abuts the side wall; light source that are arranged on a substrate surface of the light source substrate and that face the light-receiving face of the light guide plate; a frame arranged above the light-exiting surface of the light guide plate; a first inclined portion that has an inclined face provided on either one of the light source substrate and the frame, that inclines from the light guide plate side towards the side wall and from the bottom plate side towards the light-exiting surface; and a first abutting portion that is provided on another of the light source substrate and the frame, at least a portion thereof abutting the inclined face of the first inclined portion.

According to the above-mentioned illumination device, force is applied on the light source substrate from the frame side towards the light source substrate by the abutting of the first inclined portion and the first abutting portion. This force is distributed into a force towards the side wall of the chassis and a force towards the bottom plate; thus, the light source substrate can be pushed towards both the side wall and the bottom plate by the frame. Therefore, the light source substrate can be positioned and fixed to the chassis without using members such as screws. The light source substrate being pushed towards the chassis causes the light source substrate to be attached to the chassis, making it easier for heat that is generated in the vicinity of the light sources to be transferred from the light source substrate towards the chassis. This makes it possible to obtain a high heat dissipation effect. Since it is not necessary to have holes for screws in the light source substrate, the light sources can be freely arranged on the substrate, and uneven brightness caused by unequal spacing of the light sources can be prevented.

A section of the first abutting portion that abuts the first inclined portion may be a tip of a corner part. Alternatively, a section of the first abutting portion that abuts the first inclined portion may be curved. With these configurations, the light source substrate can be more effectively pushed towards the side wall and bottom plate than if the section of the first abutting portion abutting the first inclined portion were flat. Since it is not necessary to have holes for screws in the light source substrate, the light sources can be freely arranged on the light source substrate, and uneven brightness caused by unequal spacing of the light sources can be prevented.

A positioning pin may be provided on the side wall, the positioning pin protruding towards the light source substrate, and an insertion hole may be formed in a section of the light source substrate that overlaps the positioning pin, the insertion hole allowing for insertion of the pin, wherein the positioning pin is inserted in the insertion hole.

With this configuration, when the light source substrate is positioned in the manufacturing process by the positioning pin, the light source substrate can be pushed towards both the side wall and the bottom plate by the frame. Therefore, positional deviations of the light source substrate can be prevented or suppressed.

A tip of the positioning pin may protrude farther towards the light-receiving face than do light-emitting faces of the light sources.

With this configuration, the abutting of the light-receiving face of the light guide plate and the light sources, which causes the light sources to be damaged, can be prevented by the tip of the positioning pin abutting the light-receiving face.

The first inclined portion may be disposed on a section of the frame that faces the light source substrate, and an end of the light source substrate that faces the frame may be the first abutting portion.

With this configuration, a configuration can be achieved in which the first inclined portion is disposed on the frame and the first abutting portion is disposed on the light source substrate.

The first inclined portion may be disposed on an end of the light source substrate that faces the frame, and the first abutting portion may be disposed on a section of the frame that faces the light source substrate, the first abutting portion protruding along a thickness direction of the light guide plate.

With this configuration, a configuration can be achieved in which the first inclined portion is disposed on the light source substrate and the first abutting portion is provided on the frame.

A second inclined portion may have an inclined face provided on an end of the light source substrate facing the bottom plate, the second inclined portion inclining from the side wall side towards the light guide plate and inclining from the bottom plate side towards the frame, and a second abutting portion may be provided on a section of the bottom plate that faces the light source substrate, the second abutting portion protruding along a thickness direction of the light guide plate, wherein the inclined face of the second inclined portion abuts a part of the second abutting portion.

With this configuration, an end of a side of the light source substrate that faces the bottom plate can be pushed towards the side wall by the second abutting portion. Therefore, the light source substrate can be more reliably fixed to the chassis.

The light source substrate may abut the bottom plate.

With this configuration, heat that is generated in the vicinity of the light sources is dissipated from the light source substrate directly towards the bottom plate; thus, the heat dissipation characteristics can be further increased.

The light source substrate may be made of metal.

With this configuration, it becomes easier for the heat to be transferred from the light source substrate towards the side wall, and thus, the heat dissipation effect can be increased.

The light sources may be point light sources, and the point light sources may be mounted on the light source substrate at equal distances to each other. In this case, the point light sources may be light emitting diode light sources.

With this configuration, it is possible to extend the life of the light sources and reduce the power consumption thereof.

The techniques disclosed in the present specification can be expressed as a display device that includes a display panel that displays images using light from the above-mentioned illumination device. Also, a display device that uses a liquid crystal panel that uses liquid crystal as the display panel is novel and useful. A television receiver that includes the above-mentioned display device is also novel and useful.

### Effects of the Invention

The technology disclosed in the present specification can provide an illumination device in which a light source substrate can be positioned and fixed to a chassis without using members such as screws.

### BRIEF DESCRIPTION OF THE DRAWINGS

FIG. 1 is an exploded perspective view of a television receiver TV according to Embodiment 1.

FIG. 2 is an exploded perspective view of a liquid crystal display device 10.

FIG. 3 is a cross-sectional view of the liquid crystal display device 10.

FIG. 4 is a cross-sectional view in which a portion of FIG. 3 has been magnified to show a cross-section in the vicinity of an LED substrate 30.

FIG. 5 is a cross-sectional view in which a portion of a liquid crystal display device 110 of Embodiment 2 has been magnified to show a cross-section in the vicinity of an LED substrate 130.

FIG. 6 is a cross-sectional view in which a portion of a liquid crystal display device 210 of Embodiment 3 has been magnified to show a cross-section in the vicinity of an LED substrate 230.

FIG. 7 is a cross-sectional view in which a portion of a liquid crystal display device 310 of Embodiment 4 has been magnified to show a cross-section in the vicinity of an LED substrate 330.

FIG. 8 is a cross-sectional view in which a portion of a liquid crystal display device 410 of Embodiment 5 has been magnified to show a cross-section in the vicinity of an LED substrate 430.

### DETAILED DESCRIPTION OF EMBODIMENTS

### Embodiment 1

Embodiment 1 will be described with reference to the drawings. Each of the drawings indicates an X axis, a Y axis, and a Z axis in a portion of the drawings, and each of the axes indicates the same direction for the respective drawings. The Y axis direction corresponds to the vertical direction and the X axis direction corresponds to the horizontal direction. Unless otherwise noted, “up” and “down” in the description is based on the vertical direction.

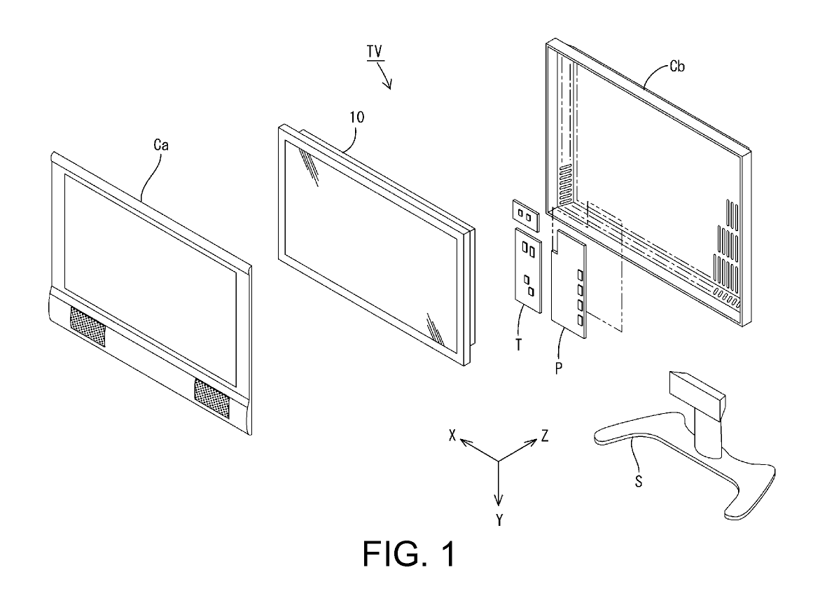

FIG. 1 is an exploded perspective view of a television receiver TV according to Embodiment 1. The television receiver TV includes a liquid crystal display device 10, front and rear cabinets Ca and Cb that store the display device D therebetween, a power source P, a tuner T, and a stand S.

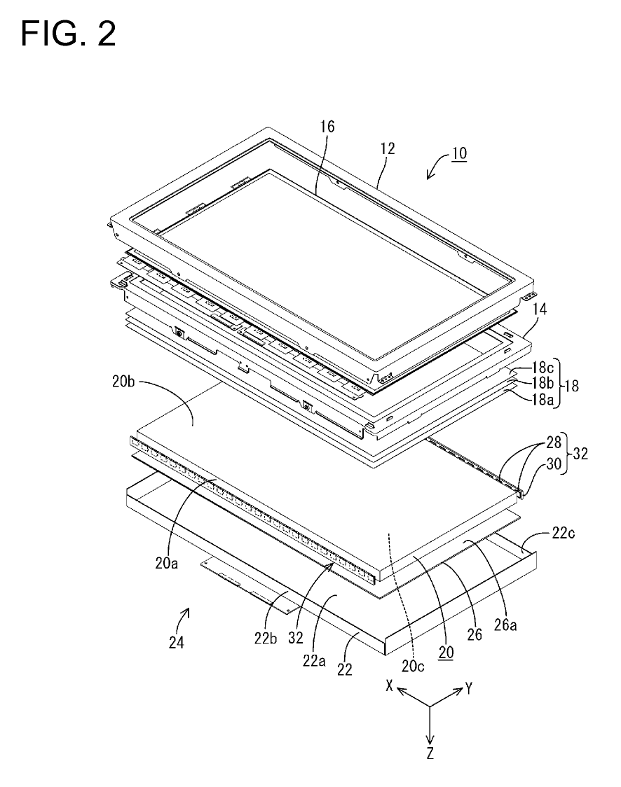

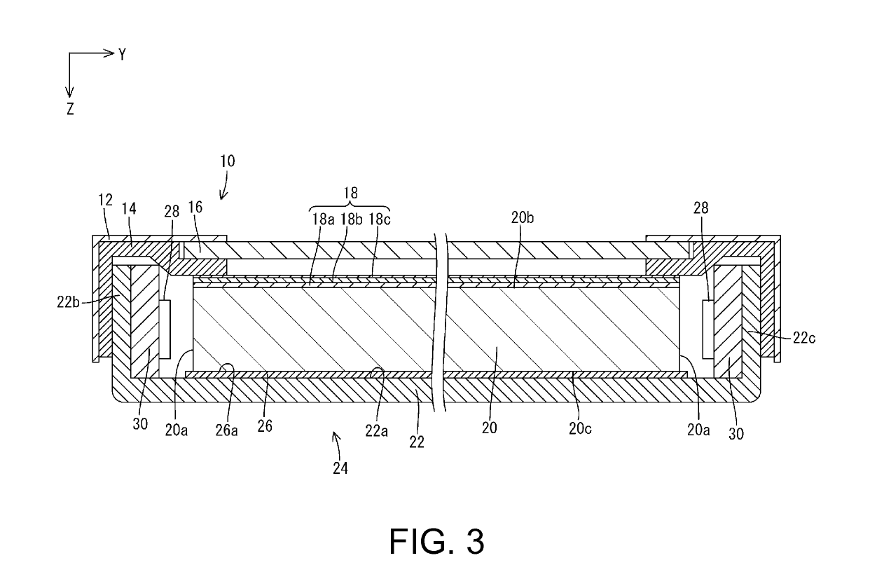

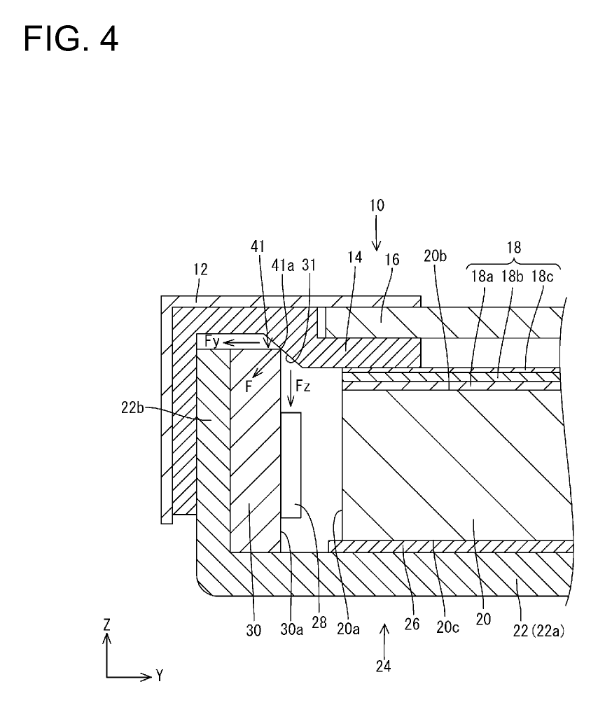

FIG. 2 is an exploded perspective view of the liquid crystal display device 10. FIG. 3 is a cross-sectional view that shows a cross-section of the liquid crystal display device 10 along the vertical direction (Y axis direction). FIG. 4 is a cross-sectional view in which a portion of FIG. 3 has been magnified to show a cross-section in the vicinity of an LED substrate 30. The top side of FIGS. 2 and 4 is the front side, and the bottom side of FIGS. 2 and 4 is the rear side. As shown in FIG. 2, the liquid crystal display device 10 is longer in the horizontal direction as a whole, includes a liquid crystal panel 16, which is a display panel, and a backlight device 24, which is an external light source, and is held together integrally with a frame-shaped bezel 12 or the like.

Next, the liquid crystal panel 16 will be described. In the liquid crystal panel 16, a pair of transparent (having a high light transmission) glass substrates are bonded together with a prescribed gap therebetween, and a liquid crystal layer (not shown in drawings) is sealed between the glass substrates. One of the glass substrates has switching elements (TFTs, for example) that are respectively connected by mutually intersecting source wiring lines and gate wiring lines with a pixel electrode connected to each of these switching elements, an alignment film, and the like. The other glass substrate has color filters with colored parts such as R (red), G (green), and B (blue) arranged in prescribed arrays, an opposite electrode, an alignment film, and the like. The source wiring lines, the gate wiring lines, the opposite electrodes, and the like are supplied with image data and various control signals necessary to display images from a driver circuit substrate that is not shown in drawings. Polarizing plates (not shown in drawings) are disposed on the outside of the glass substrates.

Next, the backlight device 24 will be described. As shown in FIGS. 2 and 3, the backlight device 24 includes a frame 14, an optical member 18, and a chassis 22. The frame 14 has a frame shape and is arranged along end sides of a surface (light-exiting surface 20b) of a light guide plate 20. The frame 14 supports the liquid crystal panel 16 along the inner edges. The optical member 18 is placed on the front side (the light-exiting surface 20b side) of the light guide plate 20. The chassis 22 has a substantially box shape that is open on the front side (light-exiting side/liquid crystal panel 16 side). A portion of the frame 14 abuts the LED substrate 30 described later, the configuration of which is described in detail later.

A pair of LED (light emitting diode) units 32 and 32, a reflective sheet 26, and a light guide plate 20 are housed inside the chassis 22. The LED units 32 and 32 are disposed on the long-side outer edges (side walls) 22b and 22c of the chassis 22, and emit light. Lengthwise direction side faces (light-receiving faces) 20a of the light guide plate 20 are disposed at positions facing the LED units 32 and 32 and guide light emitted from the LED units 32 towards the liquid crystal panel 16. The optical member 18 is placed on the front side of the light guide plate 20. In the backlight device 24 of the present embodiment, the light guide plate 20 and the optical member 18 is disposed directly below the liquid crystal panel 16, and the LED units 32, which are the light sources, are disposed on side edges of the light guide plate 20, this configuration being the so-called edge-lit type (side-light type).

The chassis 22 is made of a metal such as an aluminum-type material, for example, and is constituted of a bottom plate 22a that is rectangular in a plan view, side walls 22b and 22c that rise from the outer edges of the respective long sides of the bottom plate 22a, and side walls that rise from the outer edges of the respective short sides of the bottom plate 22a. The space inside the chassis 22 between the LED units 32 and 32 is the housing space for the light guide plate 20. On the rear side of the bottom plate 22a, a power source circuit board (not shown) that supplies power to the LED units 32, and the like are installed.

The reflective sheet 26 is placed on the front side of the bottom plate 22a of the chassis 22. The reflective sheet 26 has a light reflecting face on the front side thereof, and this light reflecting face faces the back side (opposite surface 20c) of the light guide plate 20. The reflective sheet 26 functions to reflect light back towards the opposite surface 20c of the light guide plate 20 by reflecting light that has leaked from the LED units 32 and 32.

The optical member 18 includes a diffusion sheet 18a, a lens sheet 18b, and a reflective polarizing plate 18c layered in this order from the light guide plate 20. The diffusion sheet 18a, the lens sheet 18b, and the reflective polarizing plate 18c function to convert the light emitted from the LED units 32 and transmitted through the light guide plate 20 into planar light. The liquid crystal panel 16 is disposed on the upper side of the reflective polarizing plate 18d, and the optical member 18 is disposed between the light guide plate 20 and the liquid crystal panel 16.

The LED unit 32 has a configuration in which the LED light sources 28, which emit white light, are aligned in a row on a rectangular LED substrate 30 with equal gaps therebetween. The LED substrate 30 is rectangular and made of a metal, such as aluminum, for example. The surface of the LED substrate 30 that is opposite to the surface (mounting surface 30a) on which the LED light sources 28 are arranged abuts the side walls 22b and 22c of the chassis 22. The LED light source 28 may have a configuration in which white light is emitted by having a blue light emitting element coated with a fluorescent material that has a light emitting peak in the yellow region. The LED light source 28 may alternatively have a configuration in which white light is emitted by having a blue light emitting element coated with fluorescent materials that have light emitting peaks in the green region and the red region, respectively. The LED light source 28 may also have a configuration in which white light is emitted by having a blue light emitting element coated with a fluorescent material that has a light emitting peak in the green region, and combining this with a red light emitting element. The LED light source 28 may also have a configuration in which white light is emitted by combining a blue light emitting element, a green light emitting element, and a red light emitting element. The LED light source 28 may also be a combination of an ultraviolet light emitting element with fluorescent materials. In particular, the LED light source 28 may have a configuration in which white light is emitted by having the ultraviolet light emitting element coated with fluorescent materials that have light emitting peaks in the blue, green, and red regions, respectively.

The light guide plate 20 is a rectangular plate-shaped member formed of a resin of acrylic or the like with a high transmission (high transparency), and is placed on the reflective sheet 26 and supported by the chassis 22. As shown in FIGS. 2 and 3, between the pair of LED units 32 and 32 the light guide plate 20 has the light-exiting surface 20b, which is the main plate surface of the light guide plate 20, facing the diffusion sheet 18a, and the opposite surface 20c, which is the plate surface that is opposite to the light-exiting surface 20b, facing the reflective sheet 26. By providing such a light guide plate 20, light emitted from the LED unit 32 enters the light-receiving face 20a of the light guide plate 20 and is outputted from the light-exiting surface 20b facing the diffusion sheet 18a, thus illuminating the liquid crystal panel 16 from the rear.

Next, the frame 14, and the abutting aspect of the frame 14 and LED substrate 30, which are main components of the present embodiment, will be described. As shown in FIG. 4, the inner edge of the frame-shaped frame 14 is placed on the end edge of the optical member 18, and covers the front side of the LED light source 28, LED substrate 30, and side walls 22b and 22c of the chassis 22. The outer edge of the frame 14 abuts the surface opposite to the side of the side walls 22b and 22c that abut the LED substrate 30. On the face of the frame 14 that is exposed to the LED light source 28 and LED substrate 30 side, an inclined face is provided that is inclined from the light-receiving face 20a side of the light guide plate 20 towards the side wall 22b (22c) of the chassis 22 and inclined from the bottom plate 22a side of the chassis 22 towards the light-exiting surface 20b (from the back side to front side) of the light guide plate 20. This inclined face is a first inclined portion 31 in the present embodiment.

As shown in FIG. 4, a portion (near the middle of the inclined face) of the first inclined portion 31 abuts a portion of an edge of the LED substrate 30 on the mounting surface 30a of the LED light source 28 that faces the frame 14 side. This edge is a first abutting portion 41 in the present embodiment. A section 41a of this first abutting portion 41 that abuts the first inclined portion 31 is the tip of the corner part on the light-receiving face 20a side in a cross-sectional view in FIG. 4.

In the present embodiment, the LED substrate 30 is held between the first inclined face 31 of the frame 14 and the side wall 22b (22c) of the chassis 22, and thus, the first inclined portion 31 of the frame 14 abuts the first abutting portion 41 of the LED substrate 30, thereby providing a force F to the LED substrate 30 from the first inclined portion 31 towards the first abutting portion 41 (see FIG. 4). This force F is distributed into a force Fy towards the side wall 22b (22c) of the chassis 22 and a force Fz towards the bottom plate 22a of the chassis 22 (see FIG. 4). These forces push the LED substrate 30 towards the side wall 22b (22c) and bottom plate 22a. This fixes the LED substrate 30 to the chassis 22. The first inclined portion 31 and first abutting portion 41 may be formed by attaching an elastic material such as a rubber sponge to the frame 14. With such a configuration, the first inclined portion 31 will reliably abut the first abutting portion 41 along the lengthwise direction of the LED substrate 30 and will suitably apply force on the first abutting portion 41.

The side wall 22b (22c) of the chassis 22 rises substantially vertically from the end edge of the bottom plate 22a, and an end of the side of the LED substrate 30 facing the bottom plate 22a is at a right angle to the side wall 22b (22c) side in a cross-sectional view in FIG. 4. Therefore, the LED substrate 30 is pushed towards the side wall 22b (22c) and bottom plate 22a, thereby attaching the LED substrate 30 in place to the chassis 22 with no gap (see FIG. 4). As such, the LED substrate 30 is attached to the side wall 22b (22c) of the chassis 22, making it easier for heat from the LED substrate 30 to be transferred towards the side wall 22b (22c) of the chassis. As a result, this can improve heat dissipation characteristics. The LED substrate 30 is attached to the bottom plate 22a of the chassis 22, thereby fixing the LED substrate 30 in the thickness direction (the Z-axis direction) of the light guide plate 20. This can prevent shifts in the input optical axis of light emitted from the LED light source 28 towards the light-receiving face 20a of the light guide plate 20.

In the backlight device 24 of the present embodiment as described above, the force F is applied on the LED substrate 30 from the frame 14 side towards the LED substrate 30 by the abutting of the first inclined portion 31 and the first abutting portion 41. This force F is distributed into the force Fy towards the side wall 22b (22c) and the force Fz towards the bottom plate 22a; therefore, the LED substrate 30 can be pushed both towards the side wall 22b and towards the bottom plate 22a by the frame 14. Thus, the LED substrate 30 can be positioned and fixed by being made to abut the chassis 22, with a simple configuration that does not use screws or the like. The LED substrate 30 is adhered to the chassis 22 by being pushed towards the chassis 22, making it easier for heat generated in the vicinity of the LED light source 28 to be transferred from the LED substrate 30 to the chassis 22. This can increase heat dissipation characteristics. Since it is not necessary to have holes for screws in the LED substrate 30, the LED light sources 28 can be freely arranged on the LED substrate 30, and uneven brightness caused by unequal spacing of the LED light sources 28 can be prevented.

In the backlight device 24 of the present embodiment, the LED substrate 30 can be made to directly abut the side wall 22b (22c) of the chassis 22 without using an adhesive sheet or the like; thus, higher heat dissipation characteristics can be obtained in this way than if the LED substrate 30 were fixed to the side wall 22b (22c) side of the chassis 22 through an adhesive sheet or the like. In the backlight device of the present embodiment, the LED substrate 30 can be made to directly abut the side wall 22b (22c) of the chassis 22 without using members such as screws; therefore, the manufacturing process of the backlight device 24 can be simplified and the manufacturing cost of the backlight device 24 can be reduced more than if the LED substrate 30 were fixed to the side wall 22b (22c) side of the chassis 22 using members such as screws.

In the backlight device 24 of the present embodiment, the section 41a of the first abutting portion 41 abutting the first inclined portion 31 is a tip of a corner of the LED substrate 30. Therefore, the LED substrate 30 can be more effectively pushed towards the side wall 22b and bottom plate 22a than if the section of the first abutting portion 41 abutting the first inclined portion 31 were flat.

In the backlight device 24 of the present embodiment, as described above, the first inclined portion 31 is disposed on a section of the frame 14 that faces the LED substrate 30 side, and the end of the LED substrate 30 that faces the frame 14 side is the first abutting portion 41. Due to this, a configuration is achieved in which the first inclined portion 31 is disposed on the frame 14 and the first abutting portion 41 is disposed on the LED substrate 30.

In the backlight device 24 of the present embodiment, the LED substrate abuts the bottom plate 22a. In this way, heat that is generated in the vicinity of the LED light source 28 is dissipated from the LED substrate 30 directly towards the bottom plate 22a; thus, the heat dissipation characteristics can be further increased.

In the backlight device 24 of the present embodiment, the LED substrate 30 is made of a metal. This makes it easy for the heat to be transferred from the LED substrate 30 towards the side wall 22b (22c), and thus, the heat dissipation effect can be increased.

### Embodiment 2

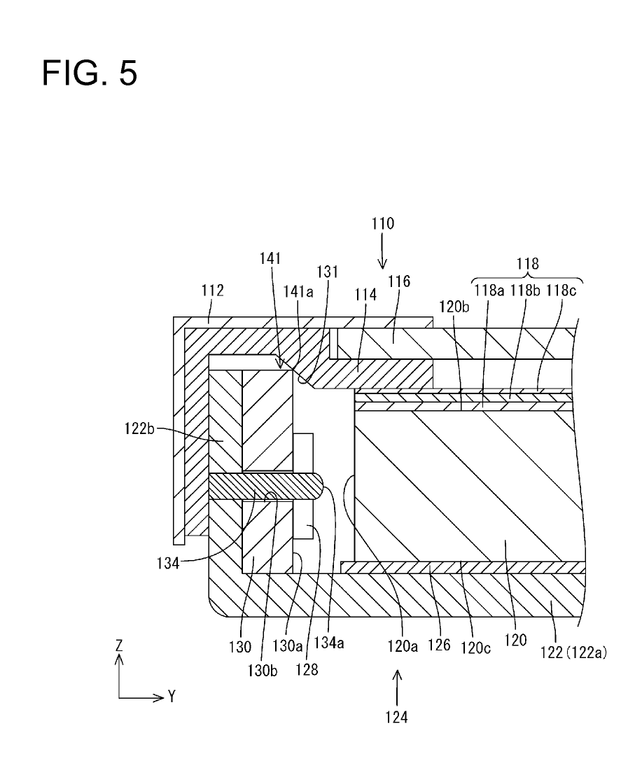

Embodiment 2 will be described with reference to the drawings. FIG. 5 is a cross-sectional view in which a portion of a liquid crystal display device 110 of Embodiment 2 has been magnified to show a cross-section in the vicinity of an LED substrate 130. Embodiment 2 differs from Embodiment 1 in that the LED substrate 130 is positioned by a positioning pin 134. Other configurations are similar to those of Embodiment 1, and therefore, descriptions of the configurations, the operation, and the effect will be omitted. Parts in FIG. 5 that have 100 added to the reference characters of FIG. 4 are the same as these parts described in Embodiment 1.

As shown in FIG. 5, in a backlight device 124 of Embodiment 2 the positioning pin 134, which protrudes towards a light-receiving face 120a of a light guide plate 120, is disposed on a side wall 122b (122c) of a chassis 122. An insertion hole 130b that has a size allowing for insertion of the positioning pin 134 is disposed in a section of the LED substrate 130 that overlaps the positioning pin 134 in the plane direction. The positioning pin 134 penetrates the insertion hole 130b in the LED substrate 130, and a tip 134a of the positioning pin 134 faces the light-receiving face 120a side. The tip of the positioning pin 134 protrudes further towards the light-receiving face 120a than does the light-emitting face of an LED light source 128.

With such a configuration, in the backlight device 124, the LED substrate 130 can be positioned in advance with the positioning pin 134 during the manufacturing process by inserting the positioning pin 134 in the insertion hole 130b in the LED substrate 130. When the LED substrate 130 is positioned, the LED substrate 130 can be pushed towards both the side wall 122b (122c) and the bottom plate 122a by a frame 114. Accordingly, in the manufacturing process, it is not necessary to impose the frame 114 while holding the LED substrate 130, and thus, this makes it easier to impose the frame 114.

Having a smaller gap between the LED light source 128 and the light-receiving face 120a of the light guide plate 120 increases light-receiving efficiency, but if there is barely any gap between these two (i.e., if the LED light source 128 and light-receiving face 120a of the light guide plate 120 are adjacent), then there is a risk that vibrations or the like exerted on the backlight device 124 will damage the LED light source 128 due to the light-receiving face 120a of the light guide plate 120 abutting the light-emitting face of the LED light source 128. As a countermeasure, in the backlight device 124 of the present embodiment, the tip of the positioning pin 134 protrudes farther towards the light-receiving face 120a of the light guide plate 120 than does the light-emitting surface of the LED light source 128; therefore, even if vibrations or the like are exerted on the backlight device 124, the abutting of the light-receiving face 120a of the light guide plate 120 and the light-emitting face of the LED light source 128 can be prevented by the light-receiving face 120a of the light guide plate 120 abutting the tip of the positioning pin 134. Thus, damage to the LED light source 128 can be prevented.

### Embodiment 3

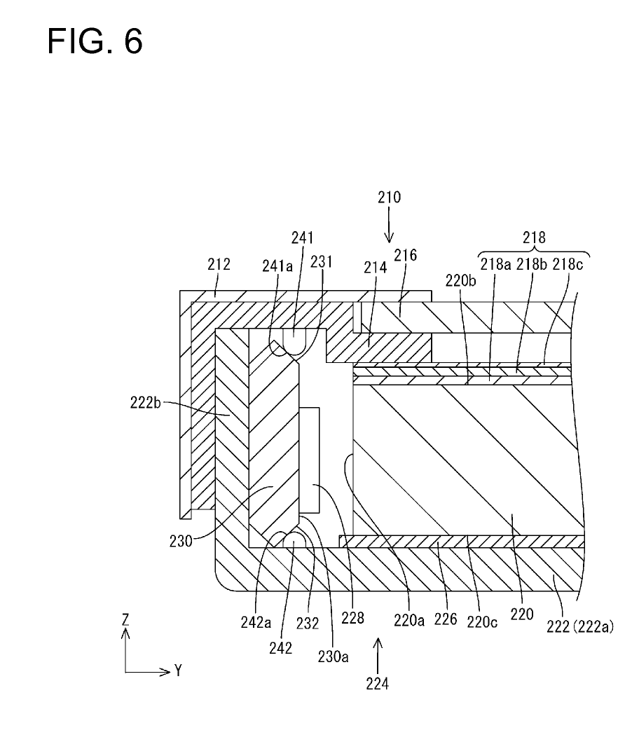

Embodiment 3 will be described with reference to the drawings. FIG. 6 is a cross-sectional view in which a portion of a liquid crystal display device 210 of Embodiment 3 has been magnified to show a cross-section in the vicinity of an LED substrate 230. Embodiment 3 differs from Embodiment 1 in that a first inclined portion 231 and second inclined portion 232 are disposed on the LED substrate 230, a first abutting portion 241 is disposed on a frame 214, and a second abutting portion 242 is disposed on a bottom plate 222a. Other configurations are similar to those of Embodiment 1, and therefore, descriptions of the configurations, the operation, and the effect will be omitted. Parts in FIG. 6 that have 200 added to the reference characters of FIG. 4 are the same as these parts described in Embodiment 1.

As shown in FIG. 6, in the backlight device 224 of Embodiment 3, the LED substrate 230 has a hexagonal shape in a cross-sectional view. In other words, on the LED substrate 230, two mound-shaped inclined faces each are disposed on an end facing the frame 214 and an end facing the bottom plate 222a. Of the two inclined faces disposed on the end of the LED substrate 230 facing the frame 214, the inclined face that faces a light-receiving face 220a of a light guide plate 220 is inclined from the light-receiving face 220a side towards a side wall 222b of a chassis 222 and inclined from the bottom plate 222a side of the chassis 222 towards a light-exiting surface 220b of the light guide plate 220 (from the back side to the front side). This is the first inclined portion 231. Of the two inclined faces disposed on the end of the LED substrate 230 facing the bottom plate 222a, the inclined face that faces the light-receiving face 220a side of the light guide plate 220 is inclined from the side wall 222b side of the chassis 222 towards the light-receiving face 220a of the light guide plate 220 and inclined from the bottom plate 222a side of the chassis 222 towards the light-exiting surface 220b side of the light guide plate 220 (from the back side to the front side). This is the second inclined portion 232.

As shown in FIG. 6, the first abutting portion 241, which protrudes towards the first inclined portion 231 along the thickness direction (the Z-axis direction) of the light guide plate 220, is disposed on the section of the frame 214 that faces the first inclined portion 231. The tip face of the first abutting portion 241 has a curved shape, and a portion of this tip face abuts a portion (near the middle of the inclined face) of the first inclined portion 231. Accordingly, the LED substrate 230 is held between the first abutting portion 241 disposed on the frame 214 and the side wall 222b of the chassis 222. Force is applied on the LED substrate 230 from the first abutting portion 241 towards the first inclined portion 231 by the first abutting portion 241 disposed on the frame 214 abutting the first inclined portion 231 of the LED substrate 230. This pushes the LED substrate 230 towards the side wall 222b and the bottom plate 222a and fixes the LED substrate 230 to the chassis 222.

As shown in FIG. 6, the second abutting portion 242, which protrudes towards the second inclined portion 232 along the thickness direction (the Z-axis direction) of the light guide plate 220 is disposed on the section of the bottom plate 222a that faces the second inclined portion 232. The tip face of the second abutting portion 242 has a curved shape, and a portion of this tip face abuts a portion (near the middle of the inclined face) of the second inclined portion 232. Accordingly, the LED substrate 230 is held between the second abutting portion 242 disposed on the bottom plate 222a and the side wall 222b of the chassis 222. Force is applied on the LED substrate 230 from the second abutting portion 242 towards the second inclined portion 232 by the second abutting portion 242 disposed on the bottom plate 222a abutting the second inclined portion 232 of the LED substrate 230. In this way, the LED substrate 230 can also be pushed towards the side wall 222b by the second abutting portion 242 at the end of the LED substrate 230 that faces the bottom plate 222a. Therefore, the LED substrate 230 can be more reliably fixed to the chassis 222 in combination with the effects of the first abutting portion 241 fixing the LED substrate 230 to the chassis 222.

In the backlight device 224 of Embodiment 3, a section 241a of the first abutting portion 241 that abuts the first inclined portion 231 and a section 242a of the second abutting portion 242 that abuts the second inclined portion 232 both have curved faces. Therefore, the LED substrate 230 can be more effectively pushed towards the side wall 222b and the bottom plate 222a than if the section of the first abutting portion 241 that abuts the first inclined portion 231 and the section of the second abutting portion 242 that abuts the second inclined portion 232 were flat.

In the backlight device 224 of Embodiment 3, as described above the first inclined portion 231 is disposed on an end of the LED substrate 230 facing the frame 214 side, and the first abutting portion 241 that protrudes along the thickness direction (the Z-axis direction) of the light guide plate 220 is disposed on a section of the frame 214 facing the LED substrate 230 side. Due to this, a configuration is achieved in which the first inclined portion 231 is disposed on the LED substrate 230 and the first abutting portion 241 is disposed on the frame 214.

### Embodiment 4

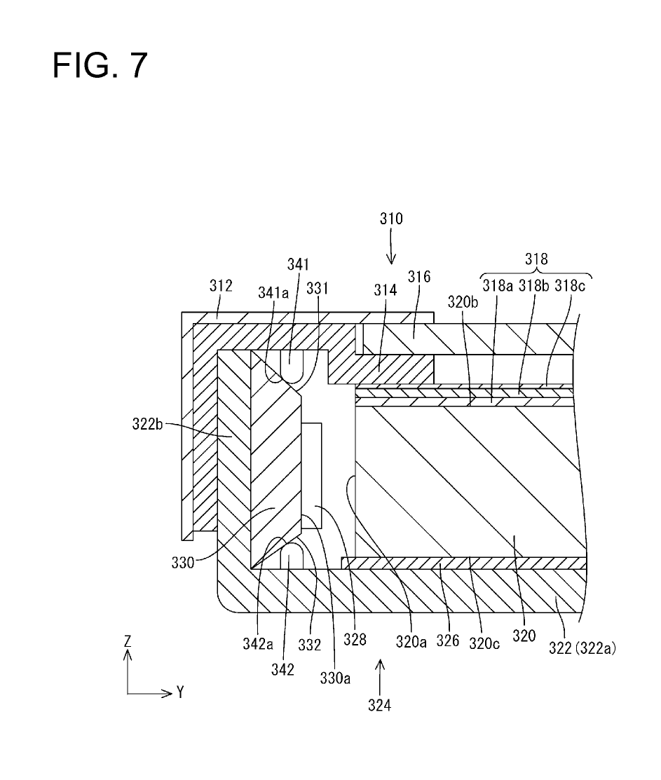

Embodiment 4 will be described with reference to the drawings. FIG. 7 is a cross-sectional view in which a portion of a liquid crystal display device 310 of Embodiment 4 has been magnified to show a cross-section in the vicinity of an LED substrate 330. The shape of an LED substrate 330 in Embodiment 4 differs from that in Embodiment 3. Other configurations are similar to those of Embodiment 3, and therefore, descriptions of the configurations, the operation, and the effect will be omitted. Parts in FIG. 7 that have 100 added to the reference characters of FIG. 6 are the same as these parts described in Embodiments 1 and 3.

As shown in FIG. 7, in a backlight device 324 of Embodiment 4, the LED substrate 330 has a trapezoidal shape in which the bottom of the LED substrate 330 is a side wall 322b in a cross-sectional view. In other words, in the LED substrate 330, one inclined face each is respectively disposed on an end that faces a frame 314 and an end that faces a bottom plate 322a. On the LED substrate 330, the inclined face disposed on the end facing the frame 314 is a first inclined portion 331, and the inclined face disposed on the end facing the bottom plate 322a is the second inclined portion 332. A portion of the tip face of a first abutting portion 341 abuts the first inclined portion 331, and a portion of the tip face of a second abutting portion 342 abuts the second inclined portion 332. Even with such a configuration, the end of the LED substrate 330 that faces the frame 314 is pushed towards the side wall 322b and the bottom plate 322a, and the end of the LED substrate 300 that faces the bottom plate 322a is pushed towards the side wall 322b, in a similar manner to Embodiment 3; thus, the LED substrate 330 can be fixed to the chassis 322.

### Embodiment 5

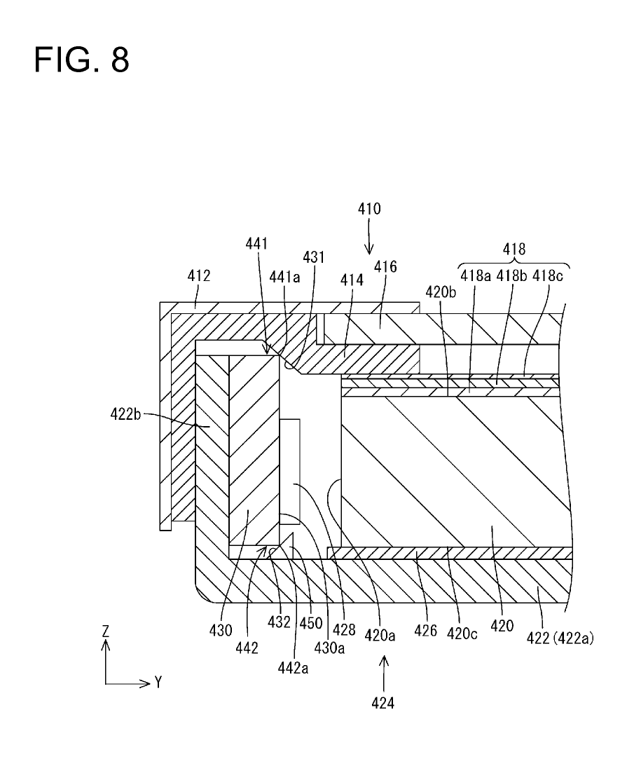

Embodiment 5 will be described with reference to the drawings. FIG. 8 is a cross-sectional view in which a portion of a liquid crystal display device 410 of Embodiment 5 has been magnified to show a cross-section in the vicinity of an LED substrate 430. Embodiment 5 differs from Embodiment 1 in that an end of the LED substrate 430 facing a bottom plate 422a is a second abutting portion 442. Other configurations are similar to those of Embodiment 1, and therefore, descriptions of the configurations, the operation, and the effect will be omitted. Parts in FIG. 7 that have 400 added to the reference characters of FIG. 4 are the same as these parts described in Embodiment 1.

As shown in FIG. 8, in a backlight device 424 of Embodiment 5, an end of the LED substrate 430 that faces the bottom plate 422a is the second abutting portion 442. In the cross-sectional view in FIG. 8, a protruding member 450 that protrudes towards the second abutting portion 442 (towards the front) is disposed on a section of the bottom plate 422a that faces a corner part of the second abutting portion 442 on a light-receiving face 420a side. The side of the protruding member 450 that faces the corner part of the second abutting portion 442 on the light-receiving face 420a side is an inclined face, and this inclined face is a second inclined portion 432.

As shown in FIG. 8, a portion of the second abutting portion 442 abuts a portion (near the center of the inclined face) of the second inclined portion 432, and a section 442a of the second abutting portion 442 that abuts the second inclined portion 432 is a tip of a corner part of the second abutting portion 442 on the light-receiving face 420a side. The LED substrate 430 is fixed at a gap from the bottom plate 422a of the chassis 422 by the second abutting portion 442 abutting the second inclined portion 432 disposed on the protruding member 450. With such a configuration, in the backlight device 424 of Embodiment 5, in addition to the effects of Embodiment 1, the end of the LED substrate 430 that faces the bottom plate 422a is pushed towards the side wall 422b by the second abutting portion 442; therefore, the LED substrate 430 can be more reliably secured to the chassis 422 than the backlight device 424 of Embodiment 1.

The corresponding relation between the configurations of each embodiment and the configurations of the present invention will be described. The LED substrates 40, 130, 230, 330, and 430 are examples of “light source substrates.” The LED light sources 28, 128, 228, 328, and 428 are examples of “light sources.” The backlight devices 24, 124, 224, 324, and 424 are examples of “illumination devices.” The liquid crystal display devices 10, 110, 210, 310, 410, and 510 are examples of “display devices.”

Modification examples of the respective embodiments above will be described below.

(1) In the respective embodiments above, the section of the first abutting portion that abuts the first inclined portion and the section of the second abutting portion that abuts the second inclined portion were described as examples of having a tip or a curved face on a corner part, but the faces of each may abut each other, and the inclined faces of each may abut each other, for example. Even if the faces of each abut each other, the LED substrate will be pushed towards the side wall; therefore, the LED substrate can be positioned to the chassis without using screws or the like.

(2) In the respective embodiments above, a portion of the first abutting portion that abuts the first inclined portion was described as an example, but the whole first abutting portion may abut the first inclined portion.

(3) In the respective embodiments above, the LED substrate being made of a metal was described as an example, but the material of the LED substrate is not limited thereto. The LED substrate may be made of a resin, for example.

(4) In the respective embodiments above, the pair of LED substrates being arranged in the chassis was described as an example, but the LED substrate may be arranged on only one of the side walls of the chassis, or four of the LED substrates may be each arranged on the respective side walls of the chassis.

(5) The respective configurations of the first inclined portion, the first abutting portion, the second inclined portion, and the second abutting portion can be appropriately modified in ways other than the respective embodiments above.

(6) In the respective embodiments above, a liquid crystal display device using a liquid crystal panel as a display panel was described as an example, but the present invention is also applicable to a display device that uses another type of display panel.

(7) In the respective embodiments above, a television receiver that includes a tuner was described as an example, but the present invention is also applicable to a display device without a tuner.

Embodiments of the present invention were described above in detail, but these are merely examples, and do not limit the scope defined by the claims. The technical scope defined by the claims includes various modifications of the specific examples described above.

Also, the technical elements described in the present specification or shown in the drawings realize technical utility each on their own or through a combination of various technical elements, and are not limited to the combinations defined by the claims at the time of filing. Also, the techniques described in the present specification or shown in the drawings can accomplish a plurality of objects simultaneously, and each one of the objects on its own has technical utility.

### DESCRIPTION OF REFERENCE CHARACTERS

TV television receiver
Ca, Cb cabinet
T tuner
S stand
10, 110, 210, 310, 410 liquid crystal display device
12, 112, 212, 312, 412 bezel
14, 114, 214, 314, 414 frame
16, 116, 216, 316, 416 liquid crystal panel
18, 118, 218, 318, 418 optical member
20, 120, 220, 320, 420 light guide plate
20a, 120a, 220a, 320a, 420a light-receiving face
22, 122, 222, 322, 422 chassis
24, 124, 224, 324, 424 backlight device
26, 126, 226, 326, 426 reflective sheet
28, 128, 228, 328, 428 LED light source
30, 130, 230, 330, 430 LED substrate
31, 131, 231, 331, 431 first inclined portion
32 LED units
41, 141, 241, 341, 441 first abutting portion
130b insertion hole
134 positioning pin
232, 332, 432 second inclined portion
241, 341, 441 second abutting portion
450 protruding member

1. An illumination device, comprising:
a chassis that has a bottom plate, and a side wall that rises on a surface side of the bottom plate from an edge of the bottom plate;
a light guide plate that has a light-receiving face as a side face thereof, a light-exiting surface disposed on one plate surface of the light guide plate, and an opposite surface disposed on another plate surface that is opposite to the light-exiting surface, the light guide plate being arranged such that said opposite surface faces the above-mentioned surface side of the bottom plate;
a light source substrate that is arranged on the surface side of the bottom plate and that abuts the side wall of the chassis;
light sources that are arranged on a substrate surface of the light source substrate and that face the light-receiving face of the light guide plate;
a frame arranged above the light-exiting surface of the light guide plate;
a first inclined portion that has an inclined face provided on either one of the light source substrate and the frame, and that inclines from the light guide plate side towards the side wall and from the bottom plate side towards the light-exiting surface of the light guide plate; and
a first abutting portion that is provided on another of the light source substrate and the frame, at least a portion thereof abutting the inclined face of the first inclined portion.

2. The illumination device according to claim 1, wherein a section of the first abutting portion that abuts the first inclined portion is a tip of a corner part.

3. The illumination device according to claim 1, wherein a section of the first abutting portion that abuts the first inclined portion is curved.

4. The illumination device according to claim 1, further comprising:
a positioning pin provided on the side wall of the chassis, the positioning pin protruding towards the light source substrate; and
an insertion hole formed in a section of the light source substrate that overlaps the positioning pin, the insertion hole allowing for insertion of the positioning pin,
wherein the positioning pin is inserted in the insertion hole.

5. The illumination device according to claim 4, wherein a tip of the positioning pin protrudes further towards the light-receiving face of the light guide plate than do light-emitting faces of the light sources.

6. The illumination device according to claim 1,
wherein the first inclined portion is disposed on a section of the frame that faces the light source substrate, and
wherein an end of the light source substrate that faces the frame is the first abutting portion.

7. The illumination device according to claim 1,
wherein the first inclined portion is disposed on an end of the light source substrate that faces the frame, and
wherein the first abutting portion is disposed on a section of the frame that faces the light source substrate, the first abutting portion protruding along a thickness direction of the light guide plate.

8. The illumination device according to claim 6, further comprising:
a second inclined portion having an inclined face provided on an end of the light source substrate facing the bottom plate, the second inclined portion inclining from the side wall side of the chassis towards the light guide plate and from the bottom plate side towards the frame; and
a second abutting portion provided on a section of the bottom plate that faces the light source substrate, the second abutting portion protruding along a thickness direction of the light guide plate,
wherein the inclined face of the second inclined portion abuts a part of the second abutting portion.

9. The illumination device according to claim 1, wherein the light source substrate abuts the bottom plate.

10. The illumination device according to claim 1, wherein the light source substrate is made of metal.

11. The illumination device according to claim 1,
wherein the light sources are point light sources, and
wherein the point light sources are mounted on the light source substrate at equal distances to each other.

12. The illumination device according to claim 11, wherein the point light sources are light emitting diode light sources.

13. A display device, comprising a display panel that performs display using light from the illumination device according to claim 1.

14. The display device according to claim 13, wherein the display panel is a liquid crystal panel using liquid crystal.

15. A television receiver, comprising the display device according to claim 13.
